(19) United States
(12) Patent Application Publication
(10) Pub. No.: US 2025/0181718 A1
(43) Pub. Date: Jun. 5, 2025

(54) DETERMINING RISKS OF SOFTWARE FILE

(71) Applicant: BlackBerry Limited, Waterloo (CA)

(72) Inventors: Mohd SAQIB, Montreal (CA); Benjamin Chin Ming FUNG, Montreal (CA)

(21) Appl. No.: 18/961,895

(22) Filed: Nov. 27, 2024

Related U.S. Application Data
(60) Provisional application No. 63/605,146, filed on Dec. 1, 2023.

(51) Int. Cl. G06F 21/56

(52) U.S. Cl. CPC G06F 21/565

(57) ABSTRACT

Systems, methods, and software can be used to determine risks of software files. In some aspects, a method includes: obtaining an input, wherein the input comprises a binary file; determining a second set of feature vectors of the input; performing a canonical correlation analysis (CCA) on the second set of feature vectors and a first set of feature vectors to obtain a first vector and a second vector; calculating a correlation coefficient value of the first vector and the second vector; obtaining a third set of feature vectors based on the correlation coefficient value; and providing, based on the third set of feature vectors, information indicating a level of a security risk of the input and information indicating features associated with the security risk of the input.

### CROSS-REFERENCE TO RELATED APPLICATIONS

This application claims priority to U.S. Provisional Application Ser. No. 63/605,146, filed Dec. 1, 2023, entitled: “HYBRID AND HIERARCHICAL EXPLAINABLE MODEL FOR MALWARE ANALYSIS,” the contents of which are hereby incorporated by reference in its entirety.

### TECHNICAL FIELD

The present disclosure relates to determining risks of a software file.

### BACKGROUND

The substantial surge in malware files render manual analysis impractical. Instead, automated malware analysis techniques are used to determine risks of software files. Machine or deep learning-based techniques can be used to perform automated malware analysis.

### DESCRIPTION OF DRAWINGS

FIG. 1 is a schematic diagram showing an example system that determines a security risk of a binary file, according to an implementation.

FIG. 2 is a flowchart showing an example process for assessing security risk of a binary file, according to an implementation.

FIG. 3 is a flowchart showing an example process for assessing security risk of a binary file, according to an implementation.

FIG. 4 illustrates an example process for pattern matching, according to an implementation.

FIG. 5 illustrates an example process for classification by using attention mechanism and SHAP value based on interpretable neural network, according to an implementation.

FIG. 6 illustrates a high-level architecture block diagram of a computer according to an implementation.

FIG. 7 shows an example pseudo code for the algorithm 1, according to an implementation.

FIG. 8 shows an example pseudo code for the algorithm 2, according to an implementation.

FIG. 9 shows an example pseudo code for the algorithm 3, according to an implementation.

FIG. 10 shows an example pseudo code for the algorithm 4, according to an implementation.

FIG. 11 provides tables for the parameters and results of the experiment, according to an implementation.

FIG. 12 illustrates distribution curves for features, according to an implementation.

FIGS. 13A and 13B show a comparison of identified features, according to an implementation.

FIG. 14 illustrates the feature reduction with and without BSX, according to an implementation.

FIG. 15 illustrates a time efficiency analysis, according to an implementation.

FIG. 16 illustrates example outputs of the risk assessment, according to an implementation.

FIG. 17 is a flowchart showing an example method for assessing security risk of a binary file, according to an implementation.

Like reference numbers and designations in the various drawings indicate like elements.

### DETAILED DESCRIPTION

The emergence of new malware strains challenges conventional detection techniques, prompting researchers to explore deep learning approaches. However, deep learning algorithms are often viewed as “black boxes,” making it difficult for security administrators to understand why a file is deemed malicious. Several studies have proposed algorithms leveraging Explainable Artificial Intelligence (XAI) to address this issue in malware detection. Yet, these methods' explanations often necessitate a strong understanding of the underlying model and fail to present findings in a format that aligns with malware analysts' methods. This research introduces a novel paradigm for explaining malicious file detection.

Machine learning-based algorithms are relatively easy to interpret and can elucidate why a system classifies a file as malicious. However, these algorithms sometimes lack accuracy and can be easily evaded. Moreover, they struggle to handle the intricate data associated with executable-based malicious files, which can take the form of assembly language, images, or graphs e.g., control flow graph (CFG), and call graph, all of which are difficult to process using machine learning. In contrast, deep learning-based methods offer robust performance and can handle diverse data types, including text, images, and graphs. However, these methods are typically seen as black-box algorithms, making them challenging to interpret and explain.

Malware analysis demands not only accurate detection but also clear, actionable explanations to counter threats effectively. Traditional Explainable AI (XAI) methods, designed for images and text, often lack the depth needed for executable data, focusing either on broad patterns or specific instances. However, malware analysis requires a model that integrates both global insights and detailed local features to stay ahead of evolving threats. To meet this need, the Hybrid and Hierarchical Explainable (H2X) model is described, which combines global explanations with localized details like numeric ranges and key Application Programming Interfaces (APIs). The H2X model can be referred to as H2X technique, H2X algorithm, H2X process, or H2X. This hybrid approach ensures a robust, comprehensive understanding of malware behavior, enhancing both detection and defense.

Furthermore, generating explanations unfolds across three levels: during the training phase, the model extracts global features; during testing and prediction, local features are computed; subsequently, the BSX (Binary Search Explanation) technique is applied to reduce the feature dimensionality. The BSX technique can be referred to as BSX model, BSX algorithm, BSX process, or BSX. The BSX is employed to select crucial malicious features and enhance the explanation's sparsity.

The H2X process employs attention mechanisms to extract global knowledge from past malware samples and highlights local features using Shapley Additive Explanations analysis. After extracting global and local features, Canonical Correlation Analysis (CCA) integrates global and local information to generate a unified explanation. Additionally, the BSX model is introduced to reduce explanation dimensionality.

Both quantitative and qualitative assessments were conducted, showing that our model surpasses state-of-the-art malware detection algorithms in performance. Qualitative assessment comprises case studies on the correctness, robustness, and sparsity of the explanations generated, which yield promising results. Furthermore, our proposed model functions as a model-agnostic explanation paradigm applicable to malware analysis and other domains. The potential of incorporating dynamic features to automate malware analysis without dependence on black box systems or manual efforts is discussed.

The novel XAI method, referred to as H2X, can be used for the explainability of malicious files. It is the first hybrid explanation method that combines model information acquired during training and that changes the explainability according to local information for specific instances. Compared to traditional XAI methods, H2X is more robust, as it incorporates information at both the model and local instance levels.

innovative hierarchical model as part of H2X is presented, to enhance the interpretability of malicious file analysis. This model acquires a broad understanding of the model's behavior through an attention layer, and subsequently refines this understanding by employing Shapley Additive Explanations (SHAP) analysis for local explanations. Additionally, the BSX algorithm can be used to serve to condense the explanation's dimensions, while maintaining accuracy and augmenting its conciseness. This unique hierarchical structure of H2X is its distinctive contribution, and the BSX algorithm stands out as an inventive approach to improving the sparsity of the explanation.

The proposed model contributes by generating comprehensive explanations for malicious executables, evaluated through metrics including correctness, robustness, and sparsity, showcasing promising results in both qualitative and quantitative assessments. Moreover, the discriminative power of the model is analyzed, surpassing existing state-of-the-art malware detectors. Furthermore, the model's throughput is assessed, outperforming recent studies in the same domain.

Malware analysis involves analyzing an unknown executable file to identify its effects, the level of impact, what has been affected, and how to mitigate the risk of compromise in the future. There are three categories of malware analysis: static, dynamic, and hybrid, each differing in the features analyzed and the depth level.

Static analysis is typically conducted to obtain initial insights into whether a file is malicious. At this stage, malware analysts analyze static features such as numeric features, printable strings, import/export tables, and opcode sequences. This stage provides the first idea about the executable file. Static analysis can easily be automated using machine learning or deep learning techniques, making it straightforward to conduct. However, static analysis cannot completely determine the file's behaviour.

Dynamic analysis is used to conduct a more in-depth analysis of the file's behaviour. In this approach, malware analysts run the executable file in a sandbox environment and observe any changes made to the system. This time-consuming approach may infect the system if the sandbox environment is not carefully implemented. Manually observing the file's behaviour is also tedious. In this approach, malware analysts examine system calls, registry changes, and memory images.

Hybrid analysis combines static and dynamic analysis and involves analyzing both types of features. It also includes reverse engineering to obtain the final functionality of any suspicious functions detected during the analysis.

XAI has been introduced to address the black-box nature of deep learning models, which is essential for gaining trust and understanding of the decisions made by these models. XAI algorithms are categorized into in-model (global) and post hoc (local) explanation methods. Global explanation XAI methods, such as attention-based neural networks, align with model training and explain model prediction. On the other hand, local explanation methods, such as Local Interpretable Model-agnostic Explanations (LIME) and SHAP analysis, interact with the model after training and produce an explanation for a specific instance, indicating what in that specific instance made the model produced that prediction.

Attention-based mechanism explains the attributes that contribute more to the prediction of the model. In this approach, the model has trainable weights for the importance of features. First, these weights assign some random numbers and during training, the model trains the weights according to training data. Once the model is trained, these weights tell us which feature is more critical in the prediction. On the other hand, SHAP analysis provides the critical feature in a particular explanation using the SHAP value. It creates many random subsets of features and compares the model's output with and without each subset.

Both global and local explanation methods have their own merits and drawbacks. For instance, for malware, it is not possible to rely on either global or local explanations alone, because the definition and attributes of malware are constantly changing. Local XAI methods based on explanations for malware may need a bigger picture of malware definition and may not relate to old malware. Attackers use obfuscation and encoding to disguise their intentions, which could be overlooked by local explanations. Therefore, H2X, a hybrid approach based on global and local explanation methods, can be used.

In recent years, explaining the detection of malicious files has become an exciting and challenging research topic. Various studies have proposed different approaches to explain malicious files. These models construct generic decision trees and utilize them to explain predictions for any malicious file. However, unlike decision tree models in machine learning, these rule-based approaches use values at hidden layers to construct the tree, which may only provide a high-level explanation to security administrators with previous knowledge of the model. Additionally, relying on a single generic rule at the global level may not be more convincing, since malware authors continually develop new signatures and parameter values to evade detection systems.

Another popular approach for explaining malicious file detection is through attention or gradient analysis. Integration of Convolutional Neural Networks (CNNs) with Recurrent Neural Networks (RNNs) has also been proposed, where attention layers were embedded in MLP models to identify critical features for classification. Support Vector Machines (SVM) can be used for classification and adjusted weights associated with features. However, these studies mainly focus on global attention extracted during the model's training, without considering the importance of local explanations. Depending solely on global attention constructed from training malicious files may be risky, as it does not account for local features modified by malicious authors through obfuscation and encoding techniques.

An alternative approach to enhance explainability using attention mechanisms is using heatmaps and grayscale images based on logic and patterns. Gradient-weighted Class Activation Mapping (Grad-CAM) has been adopted in security applications, such as malware classification. Similarly, CNN gradients can be used to identify significant bytes or image pixels. Nevertheless, the practicality of these explainability methods, which rely on visual representations such as images, may be limited in real-life scenarios. Malware analysts may struggle to comprehend these visual explanations, without prior knowledge and a comprehensive understanding of the underlying model. Furthermore, these methods predominantly focus on providing global explanations, overlooking the importance of local explanations.

In addition to rule-based and attention-based explainability, feature-based explainability is another approach that detects influential features in predictions by quantifying their importance. Local explanation models, such as LIME, SHAP, and LEMNA (Local Explanation Method using Nonlinear Approximation), provide such explanations. Several studies have utilized LIME to identify the main features in classification. SHAP has been employed for interpretability of the main features. Some studies have proposed XAI models specifically designed for security data, for example, LEMNA, a model customized for security applications. LEMNA claims to generate high-fidelity results by handling feature dependency and nonlinear local boundaries, thereby increasing explanation fidelity for cybersecurity data. However, it is essential to note that feature-based explanations, although meaningful to malware analysts, heavily depend on local explanations and can be potentially misused or evaded by malicious writers, who employ obfuscation and encoding techniques to modify local features.

Therefore, H2X, a novel framework combining global and local malware analysis explanations can be used to address the limitations of existing approaches. By incorporating elements of SHAP analysis, attention-based, and feature-based explainability, H2X aims to provide a comprehensive and interpretable solution for explaining the detection of malicious files. This approach considers the importance of both local and global explanations, allowing security stakeholders, including malware analysts and administrators, to gain insights into the model's decision-making process.

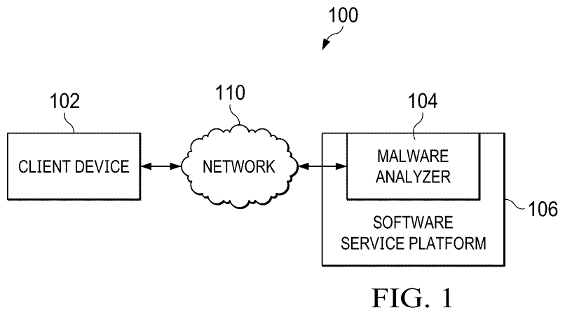

FIG. 1 is a schematic diagram showing an example system 100 that determines a security risk of a binary file, according to an implementation. At a high level, the example system 100 includes a software service platform 106 that is communicatively coupled with a client device 102 over a network 110.

The client device 102 represents an electronic device that provides the binary file to be assessed for risk determination. In some cases, the client device 102 can send the binary file to the software service platform 106 for risk determination. In some cases, the software service platform 106 can send the output of for risk determination to the client device 102.

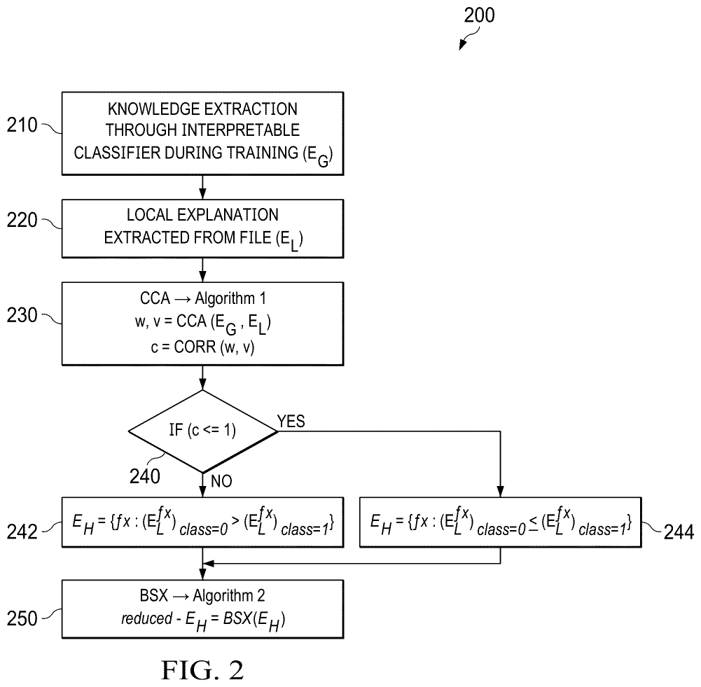

The software service platform 106 represents an application, a set of applications, software, software modules, hardware, or any combination thereof that determines security risk of a binary file. The software service platform 106 can be an application server, a service provider, or any other network entity. The software service platform 106 can be implemented using one or more computers, computer servers, or a cloud-computing platform. The software service platform 106 can be used to train machine learning models that are used in the risk determination process. The software service platform 106 includes a malware analyzer 104. The malware analyzer 104 represents an application, a set of applications, software, software modules, hardware, or any combination thereof that analyze the binary file to determine security risks. In some implementations, the malware analyzer 104 can obtain the input, determine local explanations, generate hybrid explanation, perform BSX algorithm, and provide risk assessment information. FIGS. 2-17 and associated descriptions provide additional details of these implementations.

The binary file can be a portable executable (PE) file. The binary file can include executables, object code, Dynamic Link Libraries (DLLs), or other binary code. In some cases, the binary file can contain information that an operation system loader uses to manage the executable code, such as Application Programming Interface (API) export and import tables, resource management data, and thread-local storage (TLS) data.

The binary file includes can include a stream of bytes that are generated by compiling a source code. Thus, the binary file may not be in a human-readable format and may not be easily parsed or analyzed by a human.

Turning to a general description, the client device 102 may include, without limitation, any of the following: endpoint, computing device, mobile device, mobile electronic device, user device, mobile station, subscriber station, portable electronic device, mobile communications device, wireless modem, wireless terminal, or another electronic device. Examples of an endpoint may include a mobile device, IoT (Internet of Things) device, EoT (Enterprise of Things) device, cellular phone, personal data assistant (PDA), smart phone, laptop, tablet, personal computer (PC), pager, portable computer, portable gaming device, wearable electronic device, health/medical/fitness device, camera, vehicle, or other mobile communications devices having components for communicating voice or data via a wireless communication network. A vehicle can include a motor vehicle (e.g., automobile, car, truck, bus, motorcycle, etc.), aircraft (e.g., airplane, unmanned aerial vehicle, unmanned aircraft system, drone, helicopter, etc.), spacecraft (e.g., spaceplane, space shuttle, space capsule, space station, satellite, etc.), watercraft (e.g., ship, boat, hovercraft, submarine, etc.), railed vehicle (e.g., train, tram, etc.), and other types of vehicles including any combinations of any of the foregoing, whether currently existing or after arising. The wireless communication network may include a wireless link over at least one of a licensed spectrum and an unlicensed spectrum. The term “mobile device” can also refer to any hardware or software component that can terminate a communication session for a user. In addition, the terms “user equipment,” “UE,” “user equipment device,” “user agent,” “UA,” “user device,” and “mobile device” can be used interchangeably herein.

The example system 100 includes the network 110. The network 110 represents an application, set of applications, software, software modules, hardware, or a combination thereof, that can be configured to transmit data messages between the entities in the example system 100. The network 110 can include a wireless network, a wireline network, the Internet, or a combination thereof. For example, the network 110 can include one or a plurality of radio access networks (RANs), core networks (CNs), and the Internet. The RANs may comprise one or more radio access technologies. In some implementations, the radio access technologies may be Global System for Mobile communication (GSM), Interim Standard 95 (IS-95), Universal Mobile Telecommunications System (UMTS), CDMA2000 (Code Division Multiple Access), Evolved Universal Mobile Telecommunications System (E-UMTS), Long Term Evaluation (LTE), LTE-Advanced, the fifth generation (5G), or any other radio access technologies. In some instances, the core networks may be evolved packet cores (EPCs).

While elements of FIG. 1 are shown as including various component parts, portions, or modules that implement the various features and functionality, nevertheless, these elements may instead include a number of sub-modules, third-party services, components, libraries, and such, as appropriate. Furthermore, the features and functionality of various components can be combined into fewer components, as appropriate.

FIG. 2 is a flowchart showing an example process 200 for assessing security risk of a binary file, according to an implementation. The example process 200 can be implemented by a software service platform, e.g., the software service platform 106 shown in FIG. 1. The example process 200 shown in FIG. 2 can be implemented using additional, fewer, or different operations, which can be performed in the order shown or in a different order.

As shown in FIG. 2, the process 200 can include 4 algorithms. First, at step 210, an attention mechanism is used within the neural network architecture to extract global knowledge (E_{G}) during training. For instance, the attention mechanism identifies that certain API calls, such as CreateProcess or VirtualAllocEx, are consistently associated with malicious behavior across a wide range of malware samples. Similarly, features like abnormal registry changes (RegSetValue) or specific Dynamic Link Libraries (DLL) imports (e.g., advapi32.dll) might contribute significantly to classifying files as malware in the global dataset. These insights can be encapsulated as feature importance scores or attention weights. For instance, as shown below:
E_{G}={API call usage: 0.8, Registry modification: 0.6, . . . . DLL import patterns: 0.5}

Here, the numerical scores represent the global importance of each feature in the model's decision-making process based on the training data. The global knowledge is obtained based on a training set. The training set can include binary files. In some cases, step 210 can be performed at a different device. The obtained global knowledge can be sent to the software service platform 106, e.g., prior to receiving the binary file to be assessed. Alternatively or in combination, the global knowledge can be represented by a first set of feature vectors. In an example, these feature vectors can include two types. One type of the feature vectors represent numerical features, which can include a single scalar value. Another type of feature vectors represent composite features, e.g., words, sentences, or lists, which are transformed into numerical vectors of size 16 using e.g., machine learning models such as the sentence Bidirectional Encoder Representations from Transformers (SBERT) model. In one example, the dataset of the global knowledge can include 54 numerical features and 26 composite features, each encoded as a 16-dimensional vector. In some cases, the global knowledge, e.g., the first set of feature vectors, can be updated through additional trainings based on additional binary files. In some cases, the software service platform 106 can be used to perform the training and extract the global knowledge. The global knowledge can be obtained by using algorithm 3 that will be discussed below. The global knowledge can also be referred to as global explanation.

Next, at step 220, SHAP analysis is performed to obtain local explanations (E_{L}) of the binary file to be assessed. In some cases, the binary file to be assessed can be received by the software service platform 106 from a different device, e.g., the client device 102. The binary file to be assessed can also be obtained by other ways of input, e.g., through a wired or wireless connection. The local explanations can be represented by a second set of feature vectors. In some cases, the local explanations can be obtained by using algorithm 4 that will be discussed below. The local explanations can also be referred to as local knowledge.

Once the sets of E_{G} and E_{L} are acquired, the information can be standardized, e.g., based on a common scale. This will help to facilitate comparison. In the illustrated example, Canonical Correlation Analysis (CCA) is used. CCA is a statistical technique used to investigate the relationship between two sets of variables. In our case, the two sets of variables are the attention weights, denoted as α, and the SHAP values, represented as X_{SHAP}.

At step 230, the CCA analysis is performed. Following is an example process to perform CCA between these two sets of variables:

The vectors of α and X can be standardized, representing an instance of X_{SHAP}, for which the key feature z_{w} and zₓ are extracted respectively. In this example, to standardize w, its mean is subtracted from each element and then divide by its standard deviation, where w was calculated by solving Equations 4 and 5. Equation 1 shows an example method:

$${𝒵}_{w , i} = \frac{{w}_{i} - \overline{w}}{{s}_{w}} \qquad ( 1 )$$

where i=f₁, f₂, . . . , fₙ, wᵢ represents weights of i^{th} feature (fᵢ), w̅ represents the mean, and

$$\overline{w} = \frac{{\sum }_{i = 1}^{n} {w}_{i}}{n} , {s}_{w}$$

represents the standard deviation

$${s}_{w} = \sqrt{\frac{{\sum }_{i = 1}^{n} {( {w}_{i} - \overline{w} )}^{2}}{n - 1}} .$$

Similarly, X can be standardized. Equation 2 shows an example method:

$${z}_{X , i , j} = \frac{{s}_{i , j} - \overline{s} j}{{s}_{sj}} \qquad ( 2 )$$

where i=f₁, f₂, . . . , fₙ, n represents the number of SHAP values. j represents a class label, e.g., j∈ (benign,malware), where j can take one of two values, the first value represents a label for the benign class and the second value represents a label for the malware class. s̅j represents the mean,

$$\overline{s} j = \frac{\sum i = {1}^{n} {s}_{i , j}}{n} ,$$

sₛⱼ represents the standard deviation, and

$${s}_{sj} = \sqrt{\frac{{\sum }_{i = 1}^{n} {( {s}_{i , j} - {\overline{s}}_{j} )}^{2}}{n - 1}} .$$

Next, the covariance matrix between z_{w} and zₓ can be computed. Equation 3 shows an example method:

$${C}_{ww} = Cov ( {z}_{w} , {z}_{w} ) {C}_{XX} = Cov ( {z}_{X} , {z}_{X} ) {C}_{wX} = Cov ( {z}_{w} , {z}_{X} ) {C}_{Xw} = Cov ( {z}_{w} , {z}_{X} ) \qquad ( 3 )$$

where for variables

$$X , Y , Cov ( X , y ) = \frac{{\sum }_{i = 1}^{n} ( {X}_{i} - \overline{X} ) ( {Y}_{i} - \overline{Y} )}{n - 1} .$$

The goal of CCA is to find two sets of linear combinations, w and ν, such that the correlation between the transformed variables w^{T}z_{w} and ν^{T}z_{X} is maximized:

$$maximize Corr ( {w}^{T} {z}_{w} , {v}^{T} {z}_{X} ) .$$

The optimal w and ν can be found by solving the following generalized eigenvalue problem, as shown in Equations 4 and 5.

$${C}_{ww}^{- 1 / 2} {C}_{wX} {C}_{XX}^{- 1 / 2} {C}_{Xw}^{- 1 / 2} w = λ w \qquad ( 4 )$$

$${C}_{XX}^{- 1 / 2} {C}_{Xw} {C}_{ww}^{- 1 / 2} v = λ w \qquad ( 5 )$$

where λ is a scalar representing the canonical correlation between the two sets of variables.

The resulting w and ν vectors represent the optimal linear combinations of the most highly correlated attention weights and SHAP values. By analyzing the coefficients of the resulting vectors, the features most closely related to the model's decision-making process for the malware class can be identified.

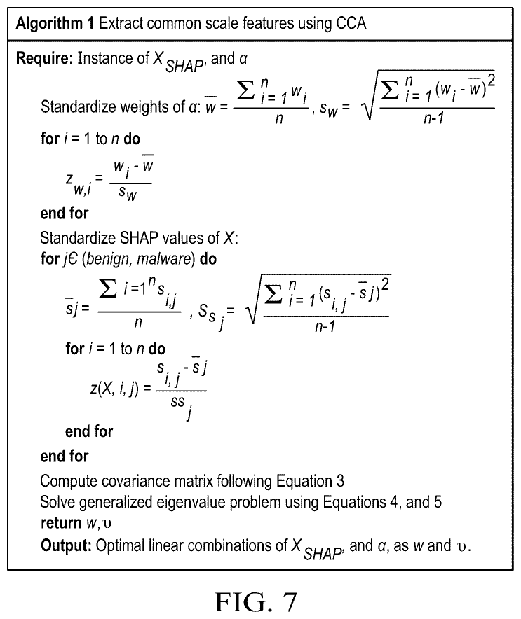

FIG. 7 shows an example pseudo code for the algorithm 1, according to an implementation.

After executing algorithm 1, the correlation coefficient values of w and ν can be obtained and it can be used to compare the global and local explanations for determining whether they are aligned. A correlation value c between w and ν can be obtained. Equation 6 is an example.

$$c = CORR ( w , v ) = \frac{E ( wv ) - E ( w ) E ( v )}{\sqrt{E ( {w}^{2} ) - E {( w )}^{2}} \sqrt{E ( {v}^{2} ) - E {( v )}^{2}}} , \qquad ( 6 )$$

where E( ) denotes expected value of the variable.

Based on this correlation coefficient, the hybrid explanation (EH) can be generated and passed to BSX to reduce the dimensionality of the explanation. The hybrid explanation can be represented as a third set of feature vectors. Following is an example method to obtain the hybrid explanation.

At 240, the correlation value c is compared to a threshold value. In one example, the threshold value is 1.

If c is greater than 1, the process 200 proceeds to 242, where the hybrid explanation can be obtained based on the following:

$${E}_{H} = \{ fx : {( {E}_{L}^{fx} )}_{class = 0} > {( {E}_{L}^{fx} )}_{class = 1} \}$$

where E_{H} represents the hybrid explanation, (E_{L}^{fx})_{class=0} represents local explanation value for feature fₓ for class=0 (being benign) and (E_{L}^{fx})_{class=1} represents local explanation for the same feature (fₓ) for class=1 (being malware).

If c is smaller than or equal to 1, the process 200 proceeds to 244, where the hybrid explanation can be obtained based on the following:

$${E}_{H} = \{ fx : {( {E}_{L}^{fx} )}_{class = 0} > {( {E}_{L}^{fx} )}_{class = 1} \}$$

At 250, the BSX is applied to reduce the dimension of the hybrid explanation.

The BSX algorithm is a recursive approach designed to explain the predictions of a machine learning (ML) model for specific instances. It is inspired by the binary search algorithm and operates by recursively dividing the feature of interest into two parts, until a minimum length of the divided list is reached.

Let x be the instance of interest and j be the feature to explain. The BSX algorithm starts by replacing all the features of x with the corresponding features of a random benign instance from the training data. The model is checked to see if it predicts x as malicious, i.e., fₓ(x)=1.

If fₓ(x)=0, the model has correctly classified the instance as benign, and there is no need to explain the prediction any further. In this case, the BSX algorithm returns an empty set.

If fₓ(x)=1, the feature j is divided into two parts, j1 and j2. Let x1 and x2 be the new instances obtained by replacing the feature j in x with j1 and j2, respectively. The either x1 or x2 is classified as malicious is checked. If both x1 and x2 are classified as benign, the feature j is abandoned and the process moves to the next feature of interest.

If either x1 or x2 is classified as malicious, the BSX algorithm is called recursively on the corresponding instance with the divided feature. This process is repeated until a minimum length of the divided list is reached, denoted byminLen.

Once the minimum length is reached, the algorithm returns a list of the most influential arguments from the divided list that led to the malicious prediction.

Equation 7 is an example to illustrate the BSX algorithm:

$$BSX ( j , x ) = \{ \begin{matrix}∅ & if {f}_{x} ( x ) = 0 \\ {S}_{1} & if {f}_{x} ( x ) = 1 and len ( j ) > minLen \\ {S}_{2} & otherwise\end{matrix} \qquad ( 7 )$$

where

$${S}_{1} = BSX ( {j}_{1} , {x}_{1} ) ⋃ BSX ( {j}_{2} , {x}_{2} ) ⋃ j \vert {f}_{x 1} ( {x}_{1} ) = 1 or {f}_{x 2} ( {x}_{2} ) = 1 \\ and \\ {S}_{2} = j \vert {f}_{x 1} ( {x}_{1} ) = 1 or {f}_{x 2} ( {x}_{2} ) = 1$$

Here, len (j) denotes the length of the list j, and minLen is the minimum length of the divided list.

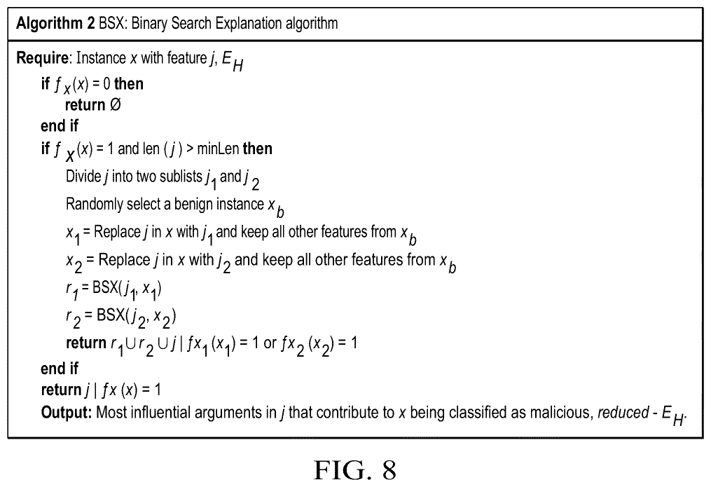

FIG. 8 shows an example pseudo code for the algorithm 2, according to an implementation.

In some implementations, the global explanation (discussed previously in step 210), can be obtained by using algorithm 3.

Algorithm 3 presents a Multi-Layer Perceptron (MLP) enhanced with an attention layer. Attention-based MLPs belong to a class of neural networks that use attention mechanisms to assess the significance of individual input features for a specific task. These models assign attention weights to each feature, using these weights to selectively emphasize the most pertinent features for precise output prediction. The attention weights are learned during training and are optimized to improve the model's overall performance.

Attention weights can be calculated using the dot product between a query vector and a key vector, followed by a softmax operation to derive a probability distribution over the input features. Equation 8 provides an example:

$${α}_{i} = \frac{exp ( {q}^{T} {K}_{i} )}{{\sum }_{j = 1}^{n} exp ( {q}^{T} {K}_{j} )} \qquad ( 8 )$$

where Kᵢ represents the i^{th} key vector, q represents the query vector, and αᵢ represents the attention weight assigned to the i^{th} input feature.

After calculating the attention weights, the key feature can be extracted by taking a weighted sum of the input features using these attention weights. Equation 9 provides an example for defining the key feature mathematically:

$${z}_{i} = {\sum }_{i = 1}^{n} {α}_{i} {x}_{i} \qquad ( 9 )$$

where xi represents the i^{th} input feature and αi represents the attention weight assigned to the i^{th} input feature.

The resulting key feature is a linear combination of the input features, with attention weights determining the importance of each input feature. This key feature summarizes the most important input features for output prediction and can serve as input for downstream tasks.

During training, both the attention weights and model parameters are jointly learned to minimize a loss function.

This loss function typically measures the discrepancy between the predicted and ground truth outputs. Equation 10 provides an example of the loss function:

$$L = \frac{1}{n} {\sum }_{i = 1}^{N} ℒ ( {y}_{i} , f ( {x}_{i} ) ) \qquad ( 10 )$$

where N is the number of training examples, xᵢ is the i^{th} input feature vector, yᵢ is the i^{th} output, f (xᵢ) is the model's prediction for the i^{th} input and L is a loss function such as mean squared error or cross-entropy.

During optimization, both the model parameters and attention weights are updated using gradient descent to minimize the loss function. Equations 11 and 12 provide example mathematical representations:

$${θ}_{t + 1} = {θ}_{t} - η {∇}_{θ} L ( {θ}_{t} , {α}_{t} ) \qquad ( 11 )$$

$${α}_{t + 1} = {α}_{t} - η {∇}_{α} L ( {θ}_{t} , {α}_{t} ) \qquad ( 12 )$$

where θt and αt represent the model parameters and attention weights at iteration t, η represents the learning rate, and ∇_{θ}L and ∇_{α}L represent the gradients of the loss function concerning the model parameters and attention weights, respectively.

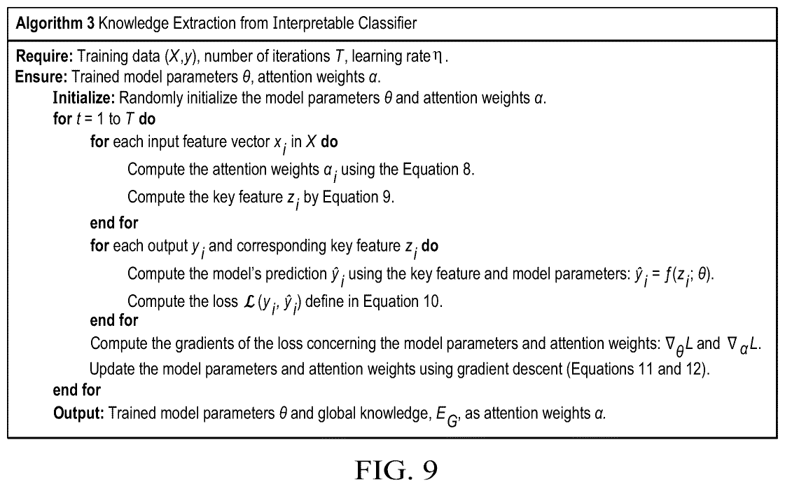

FIG. 9 shows an example pseudo code for the algorithm 3, according to an implementation.

In some implementations, the local explanation (discussed previously in step 220), can be obtained by using algorithm 4 through SHAP analysis. This algorithm can be used to attribute the contribution of each feature in the model to the prediction outcome, shedding light on the significance and impact of specific features on the final decision.

Assuming that there is an MLP model f_{θ} (x) to classify malware (1) and benign (0) executable, with input vector x∈ [symbol] , output y∈0, 1, and parameters θ. The model's prediction for a specific instance xi is to be explained

To compute the SHAP values for class c∈0, 1 at instance xᵢ, denoted by ϕ_{1,C}^{SHAP} (j), a reference distribution Pᵣ (j) for each feature j can be defined.

The SHAP value for feature j can be defined as the difference between the expected output of the model and the actual output when feature j is included, compared to when it is absent. The SHAP value can be expressed as Equation 13:

$${ϕ}_{i , c}^{SHAP} ( j ) = {\int }_{- ∞}^{∞} ( {f}_{θ} ( {x}_{i , - j}^{( j )} ; θ ) - {f}_{θ} ( {x}_{i , - j}^{( j )} ; θ ) ) {dP}_{j} ( {x}_{j} ) \qquad ( 13 )$$

where xᵢ^{(j)} is the instance xᵢ with the j^{th} feature replaced by xⱼ, and x_{i,-j}^{(j)}; is the instance xᵢ with the j-th feature replaced by its reference value. pⱼ(xⱼ) is the reference distribution for feature j. The term [f_{θ}(x_{i,-j}^{(j)};θ))−(f_{θ}(x_{i,-j}^{(j)};θ)] computes the difference in the predicted output of the model, for instance i, when a feature j is included or excluded, respectively.

To compute the integral above, the expected output of the model when its reference distribution replaces the feature j can be estimated. This can be done by averaging the output of the model over all possible instances obtained by replacing feature j with values drawn from its reference distribution. Equation 14 provides an example:

$${\hat{f}}_{- j} ( {x}_{- j} ) = \frac{1}{\vert {X}_{j} \vert} {\sum }_{{x}_{j ∈ {X}_{j}}} {f}_{θ} ( {x}_{- j , {X}_{j}} ) \qquad ( 14 )$$

where Xj is the set of possible values for feature j, and x-j is the instance xᵢ with the j^{th} feature removed.

Using the estimated expected output, the SHAP value can be rewritten by using Equation 15:

$${ϕ}_{i , c}^{SHAP} ( j ) = {\int }_{- ∞}^{∞} ( {f}_{θ} ( {x}_{i , - j}^{( j )} ; θ ) - {f}_{- j} ( {x}_{i , - j}^{( j )} ) ) {dP}_{j} ( {x}_{j} ) \qquad ( 15 )$$

This integral can be estimated using Monte Carlo integration, where n samples zⱼ^{(k)}k=1ⁿ are drawn from the reference distribution Pᵣ (j) and compute the average of the integrand. Equation 16 provides an example:

$${ϕ}_{i , c}^{SHAP} ( j ) \approx \frac{1}{n} {\sum }_{k = 1}^{n} ( {f}_{θ} ( {x}_{i}^{( j , k )} ; θ ) - {\hat{f}}_{- j} ( {x}_{i , - j}^{( j , k )} ) ) \qquad ( 16 )$$

The SHAP values for all features in the dataset are obtained, resulting in an array of shape (i, 2, d), where n is the number of instances used for prediction/testing, d is the number of features, and the 2 corresponds to the two classes, namely benign, and malware. This array is referred to as X_{SHAP}, which contains the SHAP values for all features and both classes, as shown in Equation 17.

$${X}_{SHAP} ∈ {ℝ}^{nx 2 xd} , {X}_{SHAP} ( i , c , j ) = {ϕ}_{i , c}^{SHAP} ( j ) \qquad ( 17 )$$

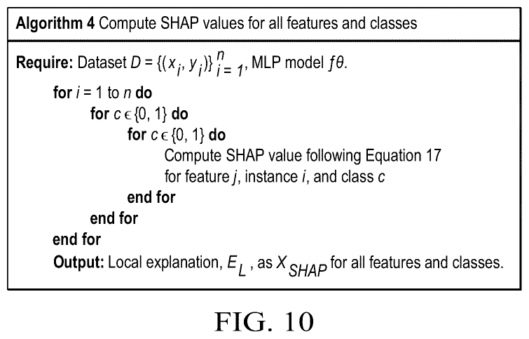

FIG. 10 shows an example pseudo code for the algorithm 4, according to an implementation.

In some cases, after the BSX algorithm discussed previously, the information indicating a level of the security risks can be provided. The information can be a classified label indicting whether the input file is malicious. The information can also be a value representing degree of the risk, derived by analyzing the change in its average of the integrand SHAP value (ϕ_{i,c}^{SHAP}(j)). Additionally or alternatively, information indicating features associated with the security risk of the input file can also be provided. The information can include descriptions of the features in the divided list. In one example, for each feature j, the absolute change in SHAP value can be calculated as: Δϕ_{i,c}^{SHAP}(j)=|ϕ_{i,c}^{SHAP}(j)_{new}−ϕ_{i,c}^{SHAP}(j)_{baseline}|, where ϕ_{i,c}^{SHAP}(j)_{new} represents the SHAP value after BSX, and, ϕ_{i,c}^{SHAP}(j)_{baseline} is the initial SHAP value. The changes across all features can be summed to get the total risk change, ΣΔϕ_{i,c}^{SHAP}(j). Based on empirical analysis or pre-defined criteria, Thresholds for multiple quantized risk levels can be defined. The risk level for the input file can be determined by matching the total risk change to the corresponding quantized risk level of the defined quantized risk levels.

In some cases, the information indicating a level of the security risk, information indicating features associated with the security risk, or both can be outputted at the user interface of the software service platform that performs the analysis. Alternatively or additionally, the information can be sent to a different device for outputting, e.g., the client device that provides the input file.

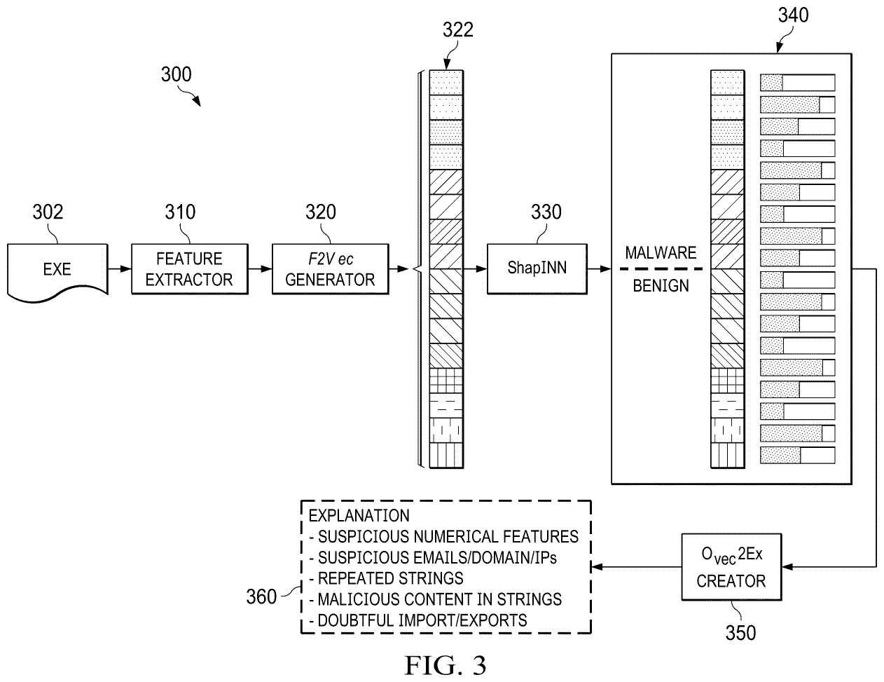

FIG. 3 is a flowchart showing an example process 300 for assessing security risk of a binary file, according to an implementation. The example process 300 can be implemented by a software service platform, e.g., the software service platform 106 shown in FIG. 1. The example process 300 shown in FIG. 3 can be implemented using additional, fewer, or different operations, which can be performed in the order shown or in a different order.

The example process 300 can be used as a framework to assess security risks of the binary file. The example process 300 includes four main stages, each utilizing components of the proposed model at different levels.

At 310, feature extraction is performed on the input file 302. The input file 302 can be a PE file. Numeric features include information about the file's size, characteristics, sections, and the number of imports and exports. Additionally, the feature extractor retrieves a list of printable strings and lists of imports and exports. In one example, 52 features are extracted from each PE file. The features include header fields, characteristics of the PE file, and statistics of the sections and resources within the file. The features are used as inputs to our subsequent components of the framework.

At 320, feature to vector generation is performed. After extracting the features from the PE files, the features are grouped and embedded to form a feature vector using F2Vec. The F2Vec algorithm assigns each feature to a specific group, where numeric features are directly assigned, and string and import/export features are assigned based on pattern matching.

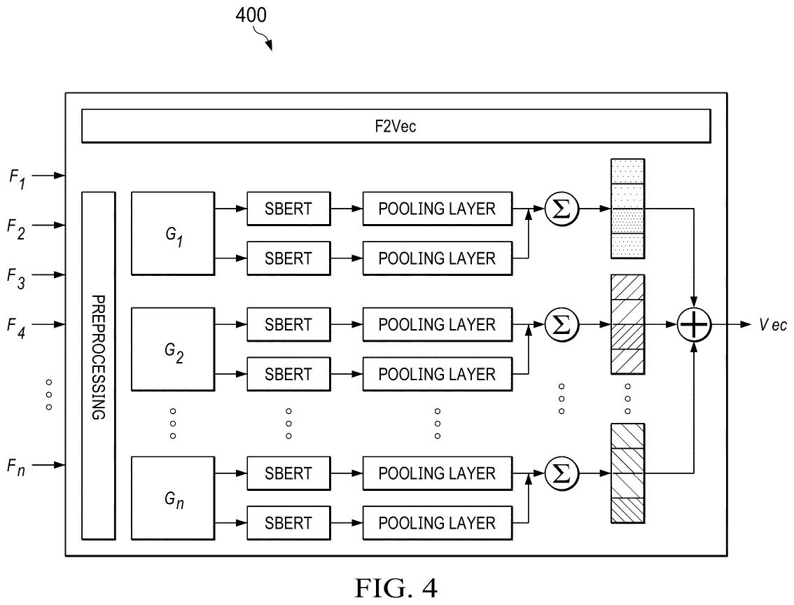

FIG. 4 illustrates an example process 400 for pattern matching, according to an implementation. Let all features extracted from the PE file be denoted by F=F1, F2, . . . , FN. Let the set of all groups be denoted by G=G1, G2, G3, . . . , GM, where M is the total number of groups. The features are assigned to their respective groups as follows:
Numeric features: F1, F2, F3, . . . , FN1∈G1
String features: FN1+1, FN1+2, FN1+3, . . . , FN1+N2∈G2
Import/export features: FN1+N2+1, FN1+N2+2, FN1+N2+3, . . . , FN1+N2+N3∈G3

After grouping the features, the elements of each group are forwarded to a sentence transformers layer, e.g., sentence-bidirectional encoder representations from transformers (SBERT) layer, to obtain embeddings, denoted by Ei, for each feature Fi. Let the embedding size be denoted by d. The embeddings are then pooled into a fixed-size vector representation, denoted by vi, using a pooling layer, such as max-pooling, average-pooling, or self-attention. Specifically, the pooling layer computes vi=Pool (Ei), where Pool is the pooling function.

For each group Gi, the pooled embeddings v(i,1), v(i,2), . . . , v(i,ki) are aggregated into a single vector ui using another pooling layer, denoted by Agg. Specifically, the aggregation layer computes ui=Agg(v(i,1), v(i,2), . . . , v(i,ki)), where ki is the number of features in group Gi.

Finally, the vectors u1, u2, . . . , uM are concatenated to form the final feature vector, denoted by x. Specifically, x=[u1, u2, . . . , uM]. The dimension of x is d, where d′=d. M.

In summary, the F2Vec algorithm assigns the extracted features to their respective groups, obtains embeddings for each feature using sentence transformer algorithm (e.g., SBERT), pools the embeddings into fixed-size vectors, aggregates the vectors for each group, and after joining them, creates a vector 322 for input in the classifier.

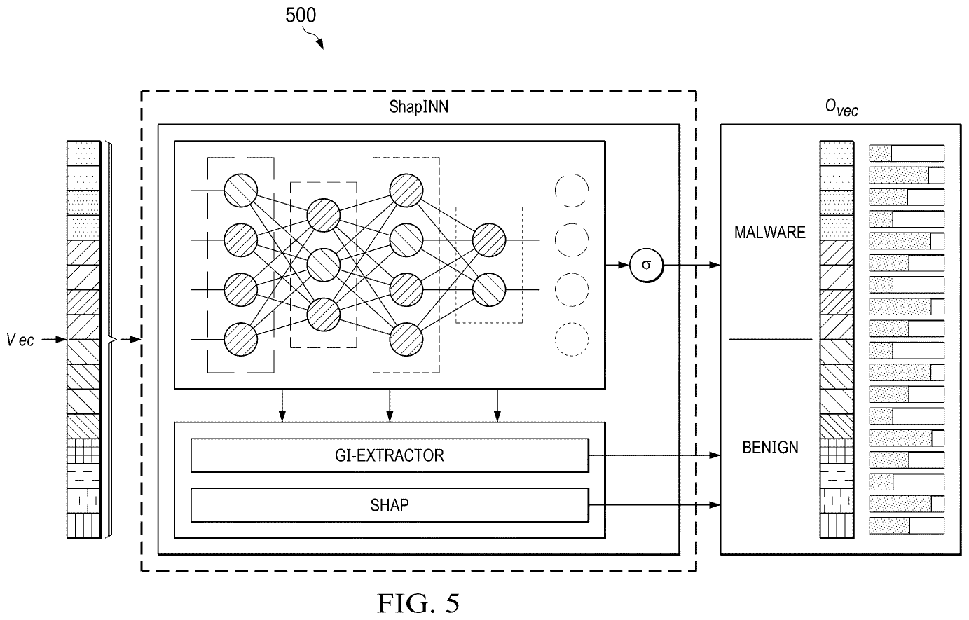

Returning to FIG. 3, at 330, interpretable classification is performed. In one example, the vector generated by F2Vec (vector 322) is passed to an attention-based MLP. The MLP includes multiple layers of hidden neurons, each with its own set of weights and biases. FIG. 5 illustrates an example process 500 for classification by using attention mechanism and SHAP value based interpretable neural network, according to an implementation.

Let x E Rn be the input vector, where n is the dimension of the vector. The output of the MLP can be represented as:

$${h}_{1} = σ ( {W}_{1 X} + {b}_{1} ) \\ {h}_{2} = σ ( {W}_{2 {h}_{1}} + {b}_{2} ) \\ {h}_{L} = σ ( WLhL - 1 + {b}_{L} )$$

where W₁, W₂ . . . , W_{L} are the weight matrices, b₁, b₂ . . . , b_{L} are the bias vectors, σ is the activation function, in this case rectified linear unit (ReLU), and L is the number of layers. The output of the final layer, h_{L}, is then passed through a sigmoid activation function to obtain the predicted probability of the input being malicious. Equation 18 shows an example:

$$\hat{𝒴} = σ ( {w}^{T} {h}_{L} + b ) \qquad ( 18 )$$

where w is the weight vector and b is the bias term. To interpret the classification decision, the attention mechanism can be used. The attention mechanism computes a weight for each input feature, indicating how important that feature is in making the classification decision. Let a Σ

[symbol]

be the attention weights, with Σᵢ₌₁ⁿ aᵢ=1. The attention weights are obtained as follows:

$${z}_{1} = tanh ( {W}_{z} x + {b}_{z )} \\ a = softmax ( {v}^{T} {z}_{1} )$$

where W_{z} and b_{z} are weight matrix and bias term for the attention layer, v is a weight vector. The output of the MLP h_{L} is then weighted by the attention weights to obtain a weighted representation of the input:

$${hL}^{′} = \sum i = {1}^{n} {aih}_{L} , i$$

where h_{L}, i is the i-th element of h_{L}.

The attention weights provide an interpretable way of understanding the model's decision. The essential features can be identified by looking at the weights the attention mechanism assigns.

Returning to FIG. 3, at 350, the Ovec 2X module receives the attention output 340 from the trained model M and applies the SHAP algorithm to compute extract global and local key features that contribute the most to malware classification. This module's mathematical formulation and details have already been discussed in the previous section, which is the proposed model H2X. The output 360 is the key features and their corresponding importance scores that contribute more towards being malicious. In the illustrated example, the features can include features such as suspicious numerical features, suspicious emails/domain/Ips, repeated strings, malicious content in strings, doubtful imports/exports, and etc. As discussed previously, the features and their corresponding importance scores can be provided, e.g., output on the user interface of the software service platform 106, sent to a different device, or a combination thereof.

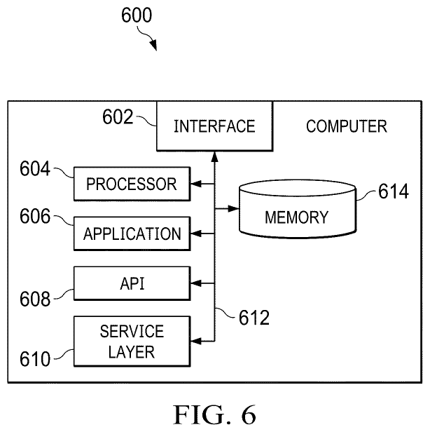

FIG. 6 illustrates a high-level architecture block diagram of a computer 600 according to an implementation. The computer 600 can be implemented as one of the software service platform 106, and the client device 102 of FIG. 1. The computer 600 can also be used to implement the operations discussed in this disclosure. The described illustration is only one possible implementation of the described subject matter and is not intended to limit the disclosure to the single described implementation. Those of ordinary skill in the art will appreciate the fact that the described components can be connected, combined, and/or used in alternative ways consistent with this disclosure.

In some cases, the processing algorithm of the code package establishment can be implemented in an executable computing code, e.g., C/C++ executable codes. In some cases, the computer 600 can include a standalone Linux system that runs batch applications. In some cases, the computer 600 can include mobile or personal computers.

The computer 600 may comprise a computer that includes an input device, such as a keypad, keyboard, touch screen, microphone, speech recognition device, other device that can accept user information, and/or an output device that conveys information associated with the operation of the computer, including digital data, visual and/or audio information, or a GUI.

The computer 600 can serve as a client, network component, a server, a database or other persistency, and/or any other components. In some implementations, one or more components of the computer 600 may be configured to operate within a cloud-computing-based environment.

At a high level, the computer 600 is an electronic computing device operable to receive, transmit, process, store, or manage data. According to some implementations, the computer 600 can also include or be communicably coupled with an application server, e-mail server, web server, caching server, streaming data server, business intelligence (BI) server, and/or other server.

The computer 600 can collect data of network events or mobile application usage events over network 110 from a web browser or a client application, e.g., an installed plugin. In addition, data can be collected by the computer 600 from internal users (e.g., from a command console or by another appropriate access method), external or third parties, other automated applications, as well as any other appropriate entities, individuals, systems, or computers.

Each of the components of the computer 600 can communicate using a system bus 612. In some implementations, any and/or all the components of the computer 600, both hardware and/or software, may interface with each other and/or the interface 602 over the system bus 612 using an API 608 and/or a service layer 610. The API 608 may include specifications for routines, data structures, and object classes. The API 608 may be either computer language-independent or -dependent and refer to a complete interface, a single function, or even a set of APIs. The service layer 610 provides software services to the computer 600. The functionality of the computer 600 may be accessible for all service consumers using this service layer. Software services, such as those provided by the service layer 610, provide reusable, defined business functionalities through a defined interface. For example, the interface may be software written in JAVA, C++, or other suitable languages providing data in Extensible Markup Language (XML) format or another suitable format. While illustrated as an integrated component of the computer 600, alternative implementations may illustrate the API 608 and/or the service layer 610 as stand-alone components in relation to other components of the computer 600. Moreover, any or all parts of the API 608 and/or the service layer 610 may be implemented as child or sub-modules of another software module, enterprise application, or hardware module without departing from the scope of this disclosure.

The computer 600 includes an interface 602. Although illustrated as a single interface 602 in FIG. 6, two or more interfaces 602 may be used according to particular needs, desires, or particular implementations of the computer 600. The interface 602 is used by the computer 600 for communicating with other systems in a distributed environment connected to a network (whether illustrated or not). Generally, the interface 602 comprises logic encoded in software and/or hardware in a suitable combination and operable to communicate with the network. More specifically, the interface 602 may comprise software supporting one or more communication protocols associated with communications such that the network or interface's hardware is operable to communicate physical signals within and outside of the computer 600.

The computer 600 includes at least one processor 604. Although illustrated as a single processor 604 in FIG. 6, two or more processors may be used according to particular needs, desires, or particular implementations of the computer. Generally, the processor 604 executes instructions and manipulates data to perform the operations of the computer 600. Specifically, the processor 604 executes the functionality disclosed in FIGS. 1-5 and 7-17.

The computer 600 also includes a memory 614 that holds data for the computer 600. Although illustrated as a single memory 614 in FIG. 6, two or more memories may be used according to particular needs, desires, or particular implementations of the computer 600. While memory 614 is illustrated as an integral component of the computer 600, in alternative implementations, memory 614 can be external to the computer 600.

The application 606 is an algorithmic software engine providing functionality according to particular needs, desires, or particular implementations of the computer 600, particularly with respect to functionality required for anomaly detection. Although illustrated as a single application 606, the application 606 may be implemented as multiple applications 606 on the computer 600. In addition, although illustrated as integral to the computer 600, in alternative implementations, the application 606 can be external to the computer 600.

There may be any number of computers 600 associated with, or external to, and communicating over a network. Furthermore, this disclosure contemplates that many users may use one computer 600, or that one user may use multiple computers 600.

In one example experiment, the dataset used in the experiment includes two categories of executables: benign files sourced from software installation paths and malicious files obtained from MalShare1 and VirusShare2. We employed ClamAV3 for identifying the malware families in the dataset, while Yara Rules4 were used to detect the top 10 packers. We utilized a total of 41,618 files for our study, comprising of 26,057 malicious files and 15,561 benign files. These files were divided into training and testing sets in an 80-20% ratio. Subsequently, the training data was further subdivided into a training set and a validation set, maintaining the same 80-20% ratio.

We conducted pre-processing on the dataset, extracting features using PE files. Numeric features related to the executables, printable strings, import/export details, and PE headers were extracted. Class-based features were encoded using label encoding, while other features were used directly.

String features were obtained through pattern matching and regular expressions, capturing URLs, directories, valid/invalid emails, unique keywords, IP addresses, file names with specific extensions, and various textual patterns. These string features were grouped accordingly and encoded using SBERT.

We extracted relevant commands for import/export features and applied the SBERT model for encoding.

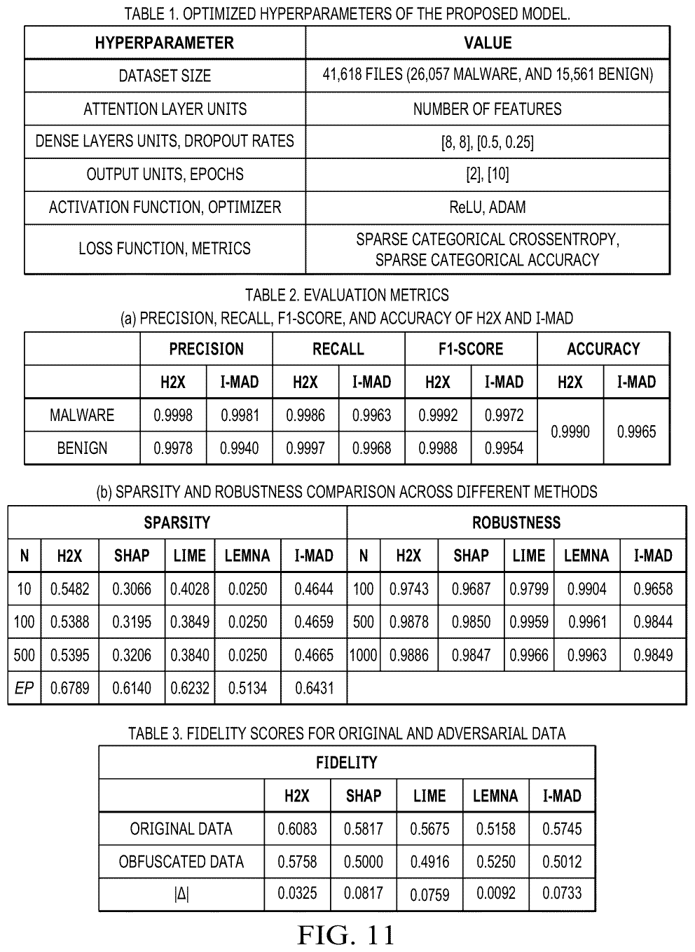

FIG. 11 provides tables for the parameters and results of the experiment, according to an implementation.

Table 1 in FIG. 11 outlines the hyperparameters used in the proposed model, which were optimized through a manual search. For state-of-the-art models used in our comparisons, we adhered to the hyperparameters specified in their original studies or utilized their default settings. Specifically, for LEMNA6 and I-MAD7, we employed the official released code. For LIME8 and SHAP9, we relied on their official Python libraries, using the default values as documented.

In this section, we present a series of experiments to demonstrate the novelty and effectiveness of the H2X model in malware analysis. To quantify the explanation power (EP) of the model, we utilize the following formula:

$$EP = \frac{{w}_{r} \times R + {w}_{s} \times S + {w}_{f} \times F}{\sum ( w )}$$

where R represents robustness, S denotes sparsity, F stands for fidelity, and ≥ (w) is the sum of the weights wr, ws, and wf assigned to these metrics.

We evaluated the discriminative power of our proposed malware classification model by comparing it with the I-MAD model, which has previously demonstrated superior performance against various benchmarks in the field. The evaluation metrics, including precision, recall, F1-Score, and accuracy, are detailed in Table 2 in FIG. 11.

The results show that the precision for benign instances was 0.9978, and for malware instances, it was 0.9998. The recall values were 0.9997 for benign instances and 0.9986 for malware instances. The F1-Score, which balances precision and recall, was 0.9988 for benign instances and 0.9992 for malware instances. Overall, the model achieved an accuracy of 0.9990.

These high values across all metrics indicate that the proposed model has strong discriminative power, effectively distinguishing between benign and malware instances. The comparison with I-MAD, as shown in Table 2, further validates the robustness and reliability of our model in malware detection.

In addition, we assess the explainability of the H2X model using various metrics, such as robustness, sparsity, and fidelity. Specifically, we evaluate the robustness of the H2X model in generating distinct explanations for files belonging to different classes, i.e., benign and malicious. To quantify robustness, we employ the Maximum Mean Discrepancy (MMD), a metric that evaluates the distribution difference between two datasets. The robustness score, which ranges between 0 and 1, indicates the extent of distributional divergence, with a score closer to 1 signifying greater distributional difference and a score of 0 indicating identical distributions. For our evaluation, we randomly selected 1,200 files from each class, benign and malicious. Explanations for these files were generated using the H2X model and compared against other state-of-the-art methods, including SHAP, I-MAD, LIME, and LEMNA. Our findings reveal that H2X outperforms SHAP and I-MAD in terms of robustness. However, LIME and LEMNA exhibit slightly higher robustness scores, potentially due to their nuanced analysis of local intrinsic behaviors.

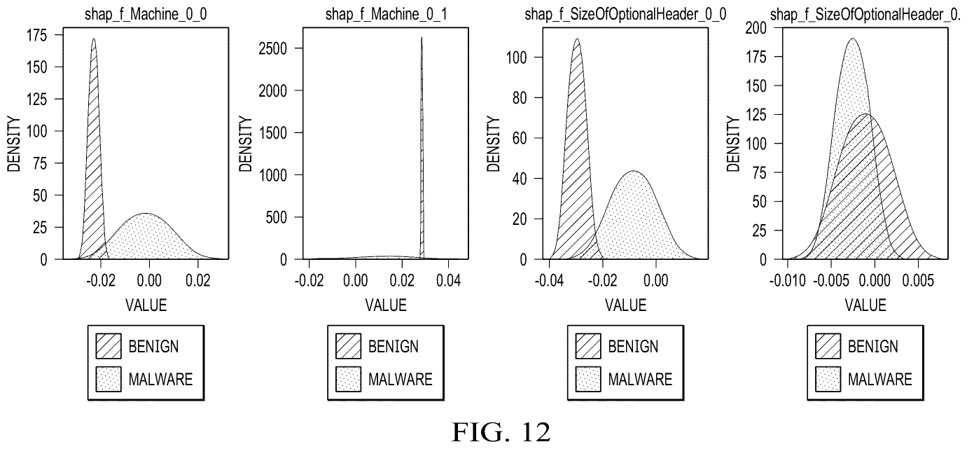

We also plotted the distribution curves for specific features across both categories of files. FIG. 12 illustrates distribution curves for features, according to an implementation. FIG. 12 includes distribution curves for selected features in benign and malicious files, illustrating the robustness of the H2X model. As shown, the curves have different shapes and magnitudes, indicating that the explanations for the two classes of files are significantly different. The curves clearly demonstrate differing distributions for the explanations generated for the two file categories. This divergence in distributions corroborates the robustness of the H2X model in producing distinct explanations for different classes of files.

We also evaluate the sparsity of the explanations generated by H2X. Sparsity measures how minimal a set of features can be while still accurately explaining a file's maliciousness. To assess sparsity, we used the same explanations for robustness, utilizing the 1,200 files selected for that analysis. Interestingly, we observed that the sparsity metric stabilized after evaluating only 500 files (see Table 2). Our findings indicate that H2X significantly outperforms all other state-of-the-art methods in terms of sparsity. In contrast, LEMNA performed the worst in this metric, suggesting that although LEMNA may exhibit higher robustness, it requires a larger number of features to provide explanations compared to H2X. Specifically, H2X needs less than 50% of the features to explain the same phenomena. By achieving high sparsity, H2X can generate explanations with fewer features, making it more efficient and easier to interpret. This capability enhances the practical applicability of H2X in real-world scenarios where concise and understandable explanations are critical.

We performed obfuscation by enhancing benign features using Alcatraz, a binary obfuscator capable of obfuscating various PE files. We ensured that the actual functionality of the binaries remained unchanged. We obfuscated 1,000 files and revisited their explanations. Changes in the explanations were expected, but to judge the correctness of the explanations, we calculated fidelity for both the original and obfuscated data

Combining global and local explanations can provide a comprehensive understanding of model behavior. Global explanations offer insights into the overall patterns and feature importance across the entire dataset, while local explanations focus on specific instances, providing detailed rationales for individual predictions. Global attention mechanisms, while powerful, can be susceptible to obfuscation and encoding techniques that mask the true nature of the data. These techniques can alter the representation of features in a way that misleads the model, thereby affecting the global explanation. Similarly, local explanations, which analyze individual instances, can also be influenced by such techniques. However, combining these approaches mitigates their individual weaknesses.

The proposed, hybrid and hierarchical model implemented using CCA, helps in the cross-verification of the model's behavior, ensuring that the identified important features are consistent across both levels. When obfuscation and encoding techniques are applied, the discrepancies between global and local explanations can reveal potential manipulation, enhancing the robustness of explanations.

Table 3 of FIG. 11 indicates that H2X consistently exhibited the highest fidelity compared to the state-of-the-art methods. Notably, SHAP and LIME showed significant reductions in fidelity when dealing with obfuscated data. Although LEMNA demonstrated resilience, its low sparsity resulted in a lower explainability potential (EP). It is crucial to highlight that the combination of global and local explanations does not amplify the vulnerability to obfuscation and encoding. Instead, it provides a more resilient and comprehensive explanation framework. By cross-referencing global patterns with local instance-specific details, we can detect inconsistencies introduced by obfuscation and encoding. This dual-level approach strengthens the overall explainability and trustworthiness of the model.

Analyzing binaries using traditional approaches that only highlight features is not sufficient, as we need to identify important values that they may hold. To demonstrate the effect of BSX, we employed a generated explanation for a file belonging to the GandCrab malware family from Ransomware11. We selected a few representative features. While numerical features are straightforward to interpret, multi-dimensional features with multiple values or lists are challenging to analyze for the most contributing values.

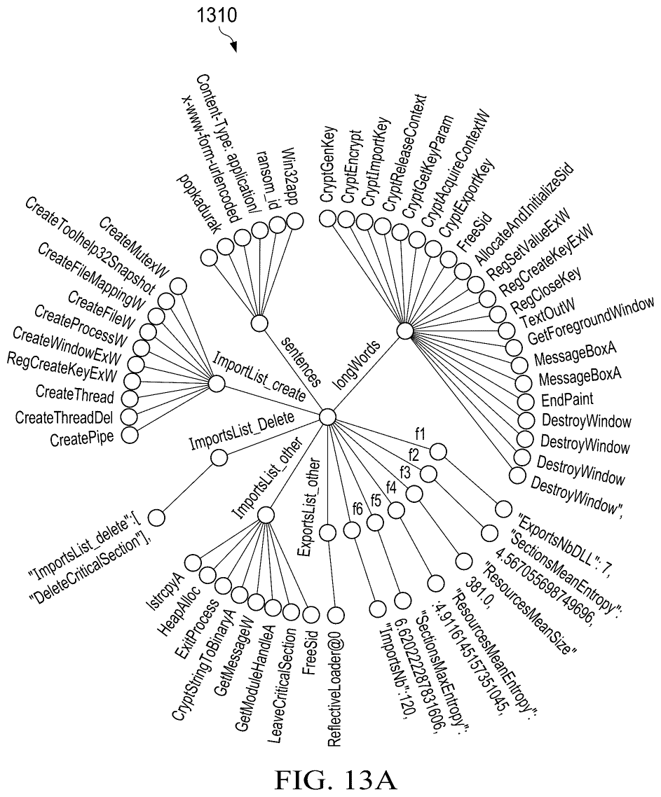

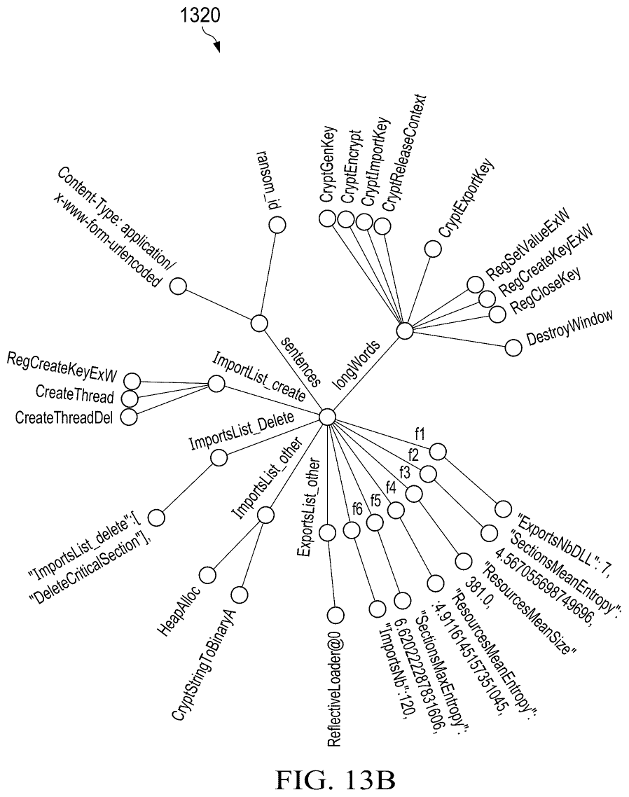

FIGS. 13A and 13B show a comparison of identified features, according to an implementation. FIG. 13A includes a diagram 1310 that shows the features identified as contributing to the model's decision, without any dimensionality reduction or prioritization of key features. FIG. 13B includes a diagram 1320 that shows the features with the application of BSX. By applying BSX, the dimensionality of the explanation is significantly reduced, focusing on the most influential features. This reduction makes the explanation more concise and interpretable. After applying BSX, the dimensionality of the explanation or these features reduces significantly, facilitating easier malware analysis, thus enhancing interpretability and usability.

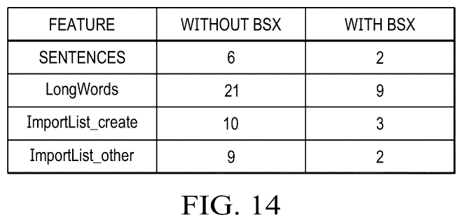

FIG. 14 illustrates the feature reduction with and without BSX, according to an implementation. FIG. 14 includes a table that shows the significant reduction in feature dimensionality when using BSX. For example, in the feature ‘LongWords’, values related to ‘Crypt’ or ‘Reg’ are chosen, indicating functionalities related to cryptocurrency and registry changes. This is consistent with the behavior of the GandCrab ransomware family. The selected features are from a small-sized file. Other examples with larger codebases exhibit even higher dimensionality. For instance, the list of imports in some malware can contain more than 1000 entries. The application of BSX demonstrates strong utility in reducing this complexity.

By showing that explanations generated with BSX are shorter, more interpretable, and we can demonstrate the practical benefits and necessity of incorporating BSX in the explanation process. This approach ensures that explanations are not only accurate but also user-friendly, aiding in better decision-making and model trustworthiness.

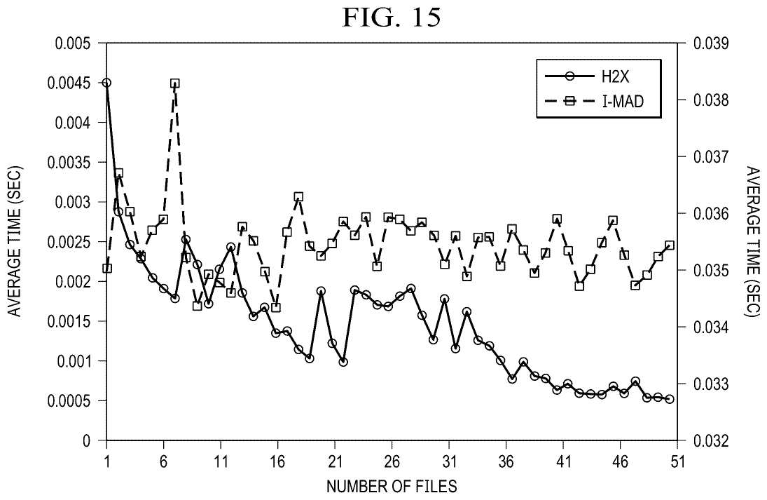

We performed a comprehensive time efficiency analysis to compare the performance of H2X and I-MAD across different batch sizes. FIG. 15 illustrates a time efficiency analysis, according to an implementation. FIG. 15 illustrates insights into the scalability and efficiency of both models. For smaller batch sizes, specifically when the number of files is less than 15, I-MAD consistently demonstrates a lower average processing time per file. This makes I-MAD an efficient choice for scenarios where the volume of data is limited or when the task requires processing files individually. This could be particularly useful in real-time analysis environments, where the ability to quickly analyze a single file is paramount.

However, as the batch size increases, I-MAD's processing time increases significantly, surpassing that of H2X. This trend highlights a critical limitation in I-MAD's scalability. Therefore, I-MAD is well-suited for scenarios requiring single-file or small-batch processing, H2X exhibits superior scalability and efficiency when handling larger datasets. In contrast, H2X is more advantageous in big data applications, where processing large volumes of files efficiently is critical.

The first case study evaluates the correctness of the explanations generated by our proposed model compared to the actual explanations that a malware analyst could generate for the same file. Unfortunately, no ground truth is available to detect the correctness of the generated explanations, and it is not easy to execute executable files (exe) in a sandbox environment to generate the ground truth. Therefore, to assess the correctness of the explanation, we randomly selected a file, generated an explanation from the proposed model, and manually investigated the extracted features and their values.

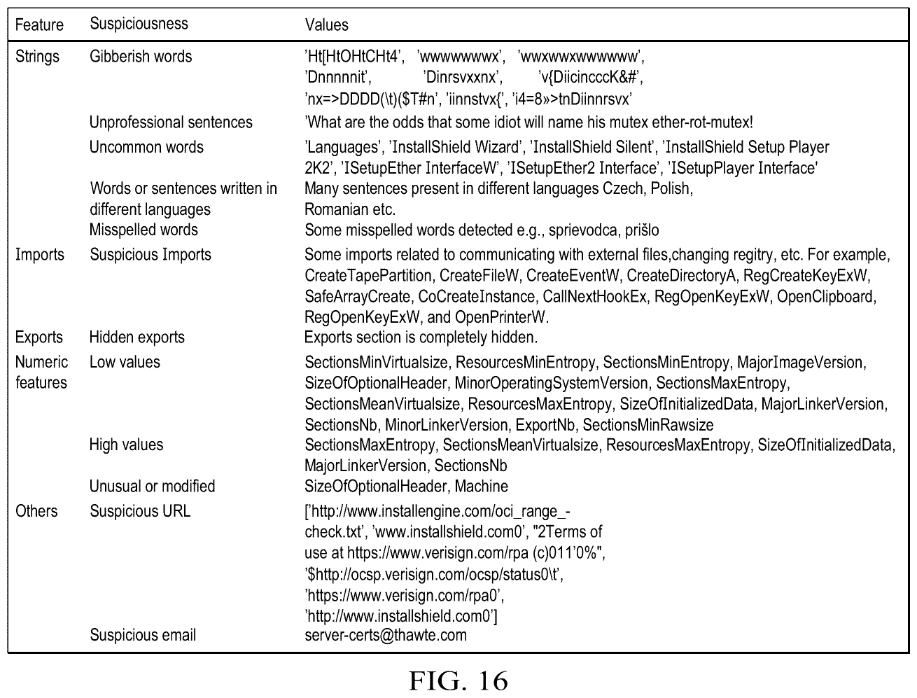

FIG. 16 illustrates example outputs of the risk assessment, according to an implementation. As shown in the table of FIG. 16, the proposed model can detect suspicious (encoded strings, multiple languages, etc.), unfamiliar (gibberish or misspelled words, etc.), or malicious features related to the printable strings, imports, and exports, and numeric features in an exe file.

Regarding the strings, our model can detect gibberish words, unprofessional sentences, uncommon words, words or sentences written in different languages, and misspelled words. These features are direct indications of malicious activity. Gibberish and misspelled words suggest that the file's author intended to hide something, which could be the obfuscation or encoding of malicious activity by the exe.

Furthermore, the imports and exports of an exe file can also provide clues about the file's maliciousness. Some imports are related to communicating with external files, changing the registry, or executing remote code, which could indicate packed malware.

Regarding numeric features, some features should fall within a specific range. If not, it looks suspicious and could indicate that the file is malicious. For instance, low values for SectionsMin Virtualsize, Resources MinEntropy, SectionsMinEntropy, MajorImage Version, SizeOfOptionalHeader, and MinorOperatingSystemVersion are suspicious. In contrast, high values for SectionsMaxEntropy, SectionsMean Virtualsize, ResourcesMaxEntropy, SizeOfInitializedData, MajorLinkerVersion, and SectionsNb are also suspicious. Additionally, if some features such as SizeOfOptionalHeader, Machine, and others are modified or have suspicious values, this could be another sign of maliciousness.

In addition, the file can also contain some external URLs and email addresses. These may not be malicious, but their presence raises awareness that the file may be doing something malicious with them.

In summary, the proposed model effectively identifies suspicious, unfamiliar, or malicious features in an executable file. The ability of the model to detect these features can assist in the early detection and prevention of malware attacks. The proposed model has demonstrated strong performance in providing explainability for classification based on static features.

Our proposed algorithm introduces a new paradigm that combines local and global explanations, leading to more reliable and interpretable explanations. Moreover, the model-agnostic nature of our approach means it can be applied across various domains. In terms of performance, our algorithm achieves a remarkable true negative rate of less than 2% and boasts a high accuracy of 98% in detecting malware instances.

Case studies on malware provide strong evidence of the model meeting the correctness requirement, with a sparsity rate of 60% and robustness scores indicating a high level of resilience. Moreover, our algorithm can detect malicious strings in any language, extending its utility beyond threats in English. It also effectively extracts indicators of compromise (IoC), such as files, applications, and processes present in the system, as well as identifying suspicious activities within administrator or privileged accounts.

By addressing the need for comprehensive explanations and offering advanced detection capabilities, our proposed algorithm presents a significant contribution to the field of malware analysis. It also serves as a foundation for further research and advancements in automated threat detection systems.

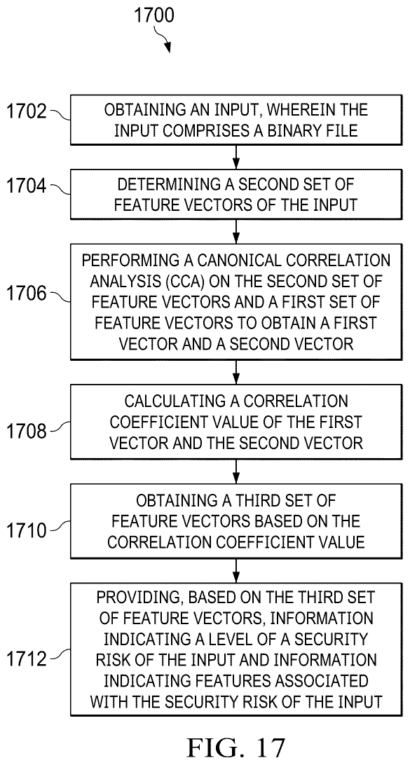

FIG. 17 is a flowchart showing an example method 1700 for assessing security risk of a binary file, according to an implementation. The example method 1700 can be implemented by a software service platform, e.g., the software service platform 106 shown in FIG. 1. The example method 1700 shown in FIG. 17 can be implemented by using additional, fewer, or different operations, which can be performed in the order shown or in a different order.

At 1702, an input is obtained. The input comprises a binary file. At 1704, a second set of feature vectors of the input is determined. At 1706, a canonical correlation analysis (CCA) is performed on the second set of feature vectors and a first set of feature vectors to obtain a first vector and a second vector. At 1708, a correlation coefficient value of the first vector and the second vector is calculated. At 1710, a third set of feature vectors is obtained based on the correlation coefficient value. At 1712, information indicating a level of a security risk of the input and information indicating features associated with the security risk of the input are provided based on the third set of feature vectors.

Described implementations of the subject matter can include one or more features, alone or in combination.

For example, in a first implementation, a method, comprising: obtaining an input, wherein the input comprises a binary file; determining a second set of feature vectors of the input; performing a canonical correlation analysis (CCA) on the second set of feature vectors and a first set of feature vectors to obtain a first vector and a second vector; calculating a correlation coefficient value of the first vector and the second vector; obtaining a third set of feature vectors based on the correlation coefficient value; and providing, based on the third set of feature vectors, information indicating a level of a security risk of the input and information indicating features associated with the security risk of the input.

The foregoing and other described implementations can each, optionally, include one or more of the following features:

A first feature, combinable with any of the following features, where performing the CCA on the second set of feature vectors and the first set of feature vectors to obtain the first vector and the second vector comprises: standardizing the second set of feature vectors and the first set of feature vectors; computing a covariance matrix based on the standardized second set of feature vectors and the standardized first set of feature vectors; and obtaining the first vector and the second vector based on the covariance matrix.

A second feature, combinable with any of the previous or following features, wherein the first vector and the second vector are obtained by using a generalized eigenvalue solution.

A third feature, combinable with any of the previous or following features, where the obtaining a third set of feature vectors based on the correlation coefficient value comprises: comparing the correlation coefficient value to a preconfigured threshold; and determining the third set of feature vectors based on the comparison.

A fourth feature, combinable with any of the previous or following features, further comprising outputting the information indicating features associated with the security risk of the input.

A fifth feature, combinable with any of the previous or following features, wherein the features comprise string features, import features, export features, or numeric features.

A sixth feature, combinable with any of the previous or following features, further comprising: performing binary search explanation (BSX) algorithm on the third set of feature vectors.

A seventh feature, combinable with any of the previous or following features, wherein the first set of feature vectors is obtained based on processing a set of binary files.

An eighth feature, combinable with any of the previous features, wherein the first set of feature vectors is updated based on one or more additional binary files.

In a second implementation, a computer-readable medium containing instructions which, when executed, cause an electronic device to perform operations comprising: obtaining an input, wherein the input comprises a binary file; determining a second set of feature vectors of the input; performing a canonical correlation analysis (CCA) on the second set of feature vectors and a first set of feature vectors to obtain a first vector and a second vector; calculating a correlation coefficient value of the first vector and the second vector; obtaining a third set of feature vectors based on the correlation coefficient value; and providing, based on the third set of feature vectors, information indicating a level of a security risk of the input and information indicating features associated with the security risk of the input.

The foregoing and other described implementations can each, optionally, include one or more of the following features:

A first feature, combinable with any of the following features, where performing the CCA on the second set of feature vectors and the first set of feature vectors to obtain the first vector and the second vector comprises: standardizing the second set of feature vectors and the first set of feature vectors; computing a covariance matrix based on the standardized second set of feature vectors and the standardized first set of feature vectors; and obtaining the first vector and the second vector based on the covariance matrix.

A second feature, combinable with any of the previous or following features, wherein the first vector and the second vector are obtained by using a generalized eigenvalue solution.

A third feature, combinable with any of the previous or following features, where the obtaining a third set of feature vectors based on the correlation coefficient value comprises: comparing the correlation coefficient value to a preconfigured threshold; and determining the third set of feature vectors based on the comparison.

A fourth feature, combinable with any of the previous or following features, the operations further comprising outputting the information indicating features associated with the security risk of the input.

A fifth feature, combinable with any of the previous or following features, wherein the features comprise string features, import features, export features, or numeric features.

A sixth feature, combinable with any of the previous or following features, the operations further comprising: performing binary search explanation (BSX) algorithm on the third set of feature vectors.

A seventh feature, combinable with any of the previous or following features, wherein the first set of feature vectors is obtained based on processing a set of binary files.

An eighth feature, combinable with any of the previous features, wherein the first set of feature vectors is updated based on one or more additional binary files.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: obtaining an input, wherein the input comprises a binary file; determining a second set of feature vectors of the input; performing a canonical correlation analysis (CCA) on the second set of feature vectors and a first set of feature vectors to obtain a first vector and a second vector; calculating a correlation coefficient value of the first vector and the second vector; obtaining a third set of feature vectors based on the correlation coefficient value; and providing, based on the third set of feature vectors, information indicating a level of a security risk of the input and information indicating features associated with the security risk of the input.

The foregoing and other described implementations can each, optionally, include one or more of the following features:

A first feature, combinable with any of the following features, where performing the CCA on the second set of feature vectors and the first set of feature vectors to obtain the first vector and the second vector comprises: standardizing the second set of feature vectors and the first set of feature vectors; computing a covariance matrix based on the standardized second set of feature vectors and the standardized first set of feature vectors; and obtaining the first vector and the second vector based on the covariance matrix.

A second feature, combinable with any of the previous or following features, wherein the first vector and the second vector are obtained by using a generalized eigenvalue solution.

A third feature, combinable with any of the previous or following features, where the obtaining a third set of feature vectors based on the correlation coefficient value comprises: comparing the correlation coefficient value to a preconfigured threshold; and determining the third set of feature vectors based on the comparison.

A fourth feature, combinable with any of the previous or following features, the operations further comprising outputting the information indicating features associated with the security risk of the input.

A fifth feature, combinable with any of the previous or following features, wherein the features comprise string features, import features, export features, or numeric features.

A sixth feature, combinable with any of the previous or following features, the operations further comprising: performing binary search explanation (BSX) algorithm on the third set of feature vectors.

A seventh feature, combinable with any of the previous or following features, wherein the first set of feature vectors is obtained based on processing a set of binary files.

An eighth feature, combinable with any of the previous features, wherein the first set of feature vectors is updated based on one or more additional binary files.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer readable media for storing computer program instructions and data can include all forms of permanent/non-permanent or volatile/non-volatile memory, media and memory devices, including by way of example semiconductor memory devices, for example, random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto optical disks; and optical memory devices, for example, digital versatile/video disc (DVD), compact disc (CD) ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back end, middleware, or front end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an API and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in XML format or other suitable formats. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A computer-implemented method, comprising:
obtaining an input, wherein the input comprises a binary file;
determining a second set of feature vectors of the input;
performing a canonical correlation analysis (CCA) on the second set of feature vectors and a first set of feature vectors to obtain a first vector and a second vector;
calculating a correlation coefficient value of the first vector and the second vector;
obtaining a third set of feature vectors based on the correlation coefficient value; and
providing, based on the third set of feature vectors, information indicating a level of a security risk of the input and information indicating features associated with the security risk of the input.

2. The computer-implemented method of claim 1, wherein performing the CCA on the second set of feature vectors and the first set of feature vectors to obtain the first vector and the second vector comprises:
standardizing the second set of feature vectors and the first set of feature vectors;
computing a covariance matrix based on the standardized second set of feature vectors and the standardized first set of feature vectors; and
obtaining the first vector and the second vector based on the covariance matrix.

3. The computer-implemented method of claim 2, wherein the first vector and the second vector are obtained by using a generalized eigenvalue solution.

4. The computer-implemented method of claim 1, wherein the obtaining a third set of feature vectors based on the correlation coefficient value comprises:
comparing the correlation coefficient value to a preconfigured threshold; and
determining the third set of feature vectors based on the comparison.

5. The computer-implemented method of claim 1, further comprising:
outputting the information indicating features associated with the security risk of the input.

6. The computer-implemented method of claim 5, wherein the features comprise string features, import features, export features, or numeric features.

7. The computer-implemented method of claim 1, further comprising: performing binary search explanation (BSX) algorithm on the third set of feature vectors.

8. The computer-implemented method of claim 1, wherein the first set of feature vectors is obtained based on processing a set of binary files.

9. The computer-implemented method of claim 1, wherein the first set of feature vectors is updated based on one or more additional binary files.

10. A computer-readable medium containing instructions which, when executed, cause an electronic device to perform operations comprising:
obtaining an input, wherein the input comprises a binary file;
determining a second set of feature vectors of the input;
performing a canonical correlation analysis (CCA) on the second set of feature vectors and a first set of feature vectors to obtain a first vector and a second vector;
calculating a correlation coefficient value of the first vector and the second vector;
obtaining a third set of feature vectors based on the correlation coefficient value; and
providing, based on the third set of feature vectors, information indicating a level of a security risk of the input and information indicating features associated with the security risk of the input.

11. The computer-readable medium of claim 10, wherein performing the CCA on the second set of feature vectors and the first set of feature vectors to obtain the first vector and the second vector comprises:
standardizing the second set of feature vectors and the first set of feature vectors;
computing a covariance matrix based on the standardized second set of feature vectors and the standardized first set of feature vectors; and
obtaining the first vector and the second vector based on the covariance matrix.

12. The computer-readable medium of claim 11, wherein the first vector and the second vector are obtained by using a generalized eigenvalue solution.

13. The computer-readable medium of claim 10, wherein the obtaining a third set of feature vectors based on the correlation coefficient value comprises:
comparing the correlation coefficient value to a preconfigured threshold; and
determining the third set of feature vectors based on the comparison.

14. The computer-readable medium of claim 10, the operations further comprising: outputting the information indicating features associated with the security risk of the input.

15. The computer-readable medium of claim 14, wherein the features comprise string features, import features, export features, or numeric features.

16. The computer-readable medium of claim 10, the operations further comprising: performing binary search explanation (BSX) algorithm on the third set of feature vectors.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining an input, wherein the input comprises a binary file;
determining a second set of feature vectors of the input;
performing a canonical correlation analysis (CCA) on the second set of feature vectors and a first set of feature vectors to obtain a first vector and a second vector;
calculating a correlation coefficient value of the first vector and the second vector;
obtaining a third set of feature vectors based on the correlation coefficient value; and
providing, based on the third set of feature vectors, information indicating a level of a security risk of the input and information indicating features associated with the security risk of the input.

18. The computer-implemented system of claim 17, wherein performing the CCA on the second set of feature vectors and the first set of feature vectors to obtain the first vector and the second vector comprises:
standardizing the second set of feature vectors and the first set of feature vectors;
computing a covariance matrix based on the standardized second set of feature vectors and the standardized first set of feature vectors; and
obtaining the first vector and the second vector based on the covariance matrix.

19. The computer-implemented system of claim 18, wherein the first vector and the second vector are obtained by using a generalized eigenvalue solution.

20. The computer-implemented system of claim 17, wherein the obtaining a third set of feature vectors based on the correlation coefficient value comprises:
comparing the correlation coefficient value to a preconfigured threshold; and
determining the third set of feature vectors based on the comparison.
